(19) United States
(12) Patent Application Publication
(10) Pub. No.: US 2011/0043826 A1
(43) Pub. Date: Feb. 24, 2011

(54) OPTICAL INFORMATION INPUT DEVICE, ELECTRONIC DEVICE WITH OPTICAL INPUT FUNCTION, AND OPTICAL INFORMATION INPUT METHOD

(75) Inventor: Kanechika KIYOSE, Matsumoto (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/851,822

(22) Filed: Aug. 6, 2010

(30) Foreign Application Priority Data
Aug. 21, 2009 (JP) 2009-191724

(51) Int. Cl. G01B 11/14

(52) U.S. Cl. 356/614

(57) ABSTRACT

An optical information input device adapted to optically detect a position of an object matter in an input area, includes: a first coordinate detection section adapted to detect a first coordinate corresponding to a position of the object matter in a first X-Y plane, which is an imaginary plane in the input area; a second coordinate detection section adapted to detect a second coordinate corresponding to a position of the object matter in a second X-Y plane, which is an imaginary plane distant from the first X-Y plane in a Z direction in the input area; and a three-dimensional information generation section adapted to generate three-dimensional information of the object matter based on the first coordinate and the second coordinate.

### BACKGROUND

1. Technical Field

The present invention relates to an optical information input device, an electronic device with an optical input function equipped with the optical information input device, and an optical information input method.

2. Related Art

For electronic devices such as cellular phones, car navigation systems, personal computers, ticket-vending machines, or banking terminals, there are used in recent years electronic devices with input function each having a touch panel disposed on the front of an image generation device such as a liquid crystal device, and in such electronic devices with the input function, information is input with reference to an image displayed on the image generation device. As a detection method in a position detection device used for such a touch panel, there are known a resistive-film type, an ultrasonic type, a capacitance type, an optical type, and so on, wherein the optical type has an advantage that a type of the object matter is not particularly limited, and at the same time has a feature of being superior in environment resistance and response speed (see JP-A-2004-295644, JP-A-2004-303172).

However, in the optical position detection device described in the documents mentioned above, although tow-dimensional position detection of the object matter can be performed, three-dimensional information of the object matter cannot be obtained, and therefore, there arises a limitation that the input method is limited.

### SUMMARY

An advantage of some aspects of the invention is to provide an optical information input device, an electronic device with an optical input function equipped with the optical information input device, and an optical information input method, each capable of using three-dimensional information of the object matter as the input while making the most use of the feature of the optical type that the input of information can be performed without a limitation in type of the object matter.

According to an aspect of the invention, there is provided an optical information input device adapted to optically detect a position of an object matter in an input area, including a first coordinate detection section adapted to detect a first coordinate corresponding to a position of the object matter in a first X-Y plane, which is an imaginary plane in the input area, a second coordinate detection section adapted to detect a second coordinate corresponding to a position of the object matter in a second X-Y plane, which is an imaginary plane distant from the first X-Y plane in a Z direction in the input area, and a three-dimensional information generation section adapted to generate three-dimensional information of the object matter based on the first coordinate and the second coordinate.

Further, according to another aspect of the invention, there is provided an optical information input method adapted to optically detect a position of an object matter in an input area, including the steps of generating a first coordinate corresponding to a position of the object matter in a first X-Y plane, which is an imaginary plane in the input area, and a second coordinate corresponding to a position of the object matter in a second X-Y plane, which is an imaginary plane distant from the first X-Y plane in a Z direction in the input area, and generating three-dimensional information of the object matter based on the first coordinate and the second coordinate.

In the aspects of the invention, the “first X-Y plane” and the “second X-Y plane” denote that it is sufficient to provide at least two “X-Y planes.” Therefore, the configuration of performing the detection in three or more “X-Y planes” is included in the scope of the invention.

In the aspects of the invention, since the positions of the object matter in the two planes distant from each other in the Z direction in the input area, namely the first X-Y plane and the second X-Y plane are generated as the first coordinate and the second coordinate, the relative positional relationship between the position of the object matter on the first X-Y plane and the position of the object matter on the second X-Y plane can be obtained based on the first coordinate and the second coordinate. Therefore, by obtaining the relative positional relationship, the three-dimensional information of the object matter can be obtained in an optical manner. Therefore, the three-dimensional information of the object matter can be used as the input information.

In this aspect of the invention, it is possible to adopt a configuration including a position detection light source adapted to emit a position detection light beam to be applied to the object matter in the input area to thereby form alight intensity distribution of the position detection light beam in the first X-Y plane and the second X-Y plane, a first light detector having a light receiving section facing to the first X-Y plane, and a second light detector having a light receiving section facing to the second X-Y plane. In the aspects of the invention, the “first light detector” and the “second light detector” denote that it is sufficient to provide at least two “light detectors.” Therefore, the configuration of performing the detection with three or more “light detectors” is included in the scope of the invention. According to the configuration described above, since the positions of the object matter on the first X-Y plane and the second X-Y plane can surely be detected, the three-dimensional information of the object matter can surely be obtained in an optical manner.

On this occasion, it is preferable to include a light guide plate adapted to take in the position detection light beam emitted from the position detection light source, and then emit the position detection light beam toward the input area. According to the configuration described above, it is possible to detect the positions of the object matter on the first X-Y plane and the second X-Y plane with a small number of position detection light sources, thus the three-dimensional information of the object matter can be obtained in an optical manner.

In this aspect of the invention, it is preferable that the three-dimensional information generation section includes a three-dimensional movement information generation section adapted to generate three-dimensional movement information corresponding to a motion of the object matter as the three-dimensional information based on a temporal variation of the first coordinate and a temporal variation of the second coordinate. In other words, it is preferable that the three-dimensional information includes the three-dimensional movement information of the object matter generated based on the temporally variation of the first coordinate and the temporally variation of the second coordinate corresponding to the motion of the object matter. According to such a configuration as described above, the three-dimensional motion of the object matter can be detected, and the three-dimensional movement information corresponding to the three-dimensional motion of the object matter can be used as the input information.

In this aspect of the invention, it is preferable that the three-dimensional movement information generation section includes at least one of a first movement information generation section adapted to generate first movement information corresponding to a movement of the object matter in the first X-Y plane as the three-dimensional movement information, a second movement information generation section adapted to generate second movement information corresponding to a movement of the object matter in the second X-Y plane as the three-dimensional movement information, a third movement information generation section adapted to generate third movement information corresponding to a movement direction when the object matter moves in the Z direction as the three-dimensional movement information, and a fourth movement information generation section adapted to generate fourth movement information corresponding to a variation of a tilt of the object matter in the input area as the three-dimensional movement information. In other words, it is possible to adopt the configuration in which the three-dimensional movement information includes at least one of the first movement information corresponding to the movement of the object matter in the first X-Y plane, the second movement information corresponding to the movement of the object matter in the second X-Y plane, the third movement information corresponding to the movement direction when the object matter moves in the Z direction, and the fourth movement information corresponding to the variation of the tilt of the object matter.

In this aspect of the invention, it is preferable that the three-dimensional movement information generation section includes a gesture information generation section adapted to specify the motion of the object matter as one of a plurality of gesture patterns based on the three-dimensional movement information to generate gesture information corresponding to the motion of the object matter. In other words, it is preferable that the three-dimensional information generation section specify the motion of the object matter as one of a plurality of gesture patterns based on the three-dimensional movement information to generate gesture information corresponding to the motion of the object matter. According to such a configuration, since it is possible to output the motion of the object matter after converting it into the gesture information, by previously correlating the gesture information and the input information with each other, the input by gestures can easily be performed.

In this aspect of the invention, it is preferable that the three-dimensional information generation section includes a tilt information generation section adapted to generate tilt information corresponding to a tilt of the object matter in the input area based on the first coordinate and the second coordinate. In other words, it is preferable that the three-dimensional information includes the tilt information corresponding to the tilt of the object matter in the input area. According to such a configuration as described above, the tilt of the object matter in the input area can also be used as the input information.

The optical information input device to which the invention is applied can be used to configure the electronic device together with the electronic device main body, and on this occasion, it is preferable to include a control section for making the electronic device main body perform operations different from each other based on the three-dimensional information. According to such a configuration as described above, gesture can be used for various operations in the electronic device.

### BRIEF DESCRIPTION OF THE DRAWINGS

The invention will be described with reference to the accompanying drawings, wherein like numbers reference like elements.

FIGS. 1A and 1B are explanatory diagrams schematically showing an optical information input device and an electronic device with an optical input function equipped with the optical information input device to which the invention is applied.

FIGS. 2A through 2C are explanatory diagrams showing a detailed configuration of the optical information input device to which the invention is applied.

FIGS. 3A and 3B are explanatory diagrams showing a content of signal processing performed in the optical information input device and the electronic device with an optical input function, to which the invention is applied.

FIG. 4 is an explanatory diagram of a control system and so on of the optical information input device to which the invention is applied.

FIGS. 5A and 5B are explanatory diagrams showing a method of detecting a three-dimensional motion of the object matter in the optical information input device and the electronic device with an optical input function, to which the invention is applied.

FIG. 6 is an explanatory diagram of coordinates and tilts of the object matter in the optical information input device and the electronic device with an optical input function, to which the invention is applied.

FIGS. 7A through 7D are explanatory diagrams showing the three-dimensional motion of the object matter used for the input in the optical information input device and the electronic device with an optical input function, to which the invention is applied.

FIGS. 8A and 8B are explanatory diagrams showing a modified example of an optical position detection device to which the invention is applied.

FIG. 9 is an exploded perspective view of an optical information input device according to a first modified example of the invention.

FIG. 10 is an explanatory diagram showing a cross-sectional configuration of the optical information input device according to the first modified example of the invention.

FIG. 11 is an exploded perspective view of an optical information input device according to a second modified example of the invention.

FIG. 12 is an explanatory diagram showing a cross-sectional configuration of the optical information input device according to the second modified example of the invention.

FIGS. 13A through 13C are explanatory diagrams of electronic devices with an optical input function according to the invention.

### DESCRIPTION OF AN EXEMPLARY EMBODIMENT

Hereinafter, an embodiment of the invention will be explained in detail with reference to the accompanying drawings.

Configuration of Optical Information Input Device and Electronic Device with Optical Input Function
Overall Configuration of Electronic Device with Optical Input Function

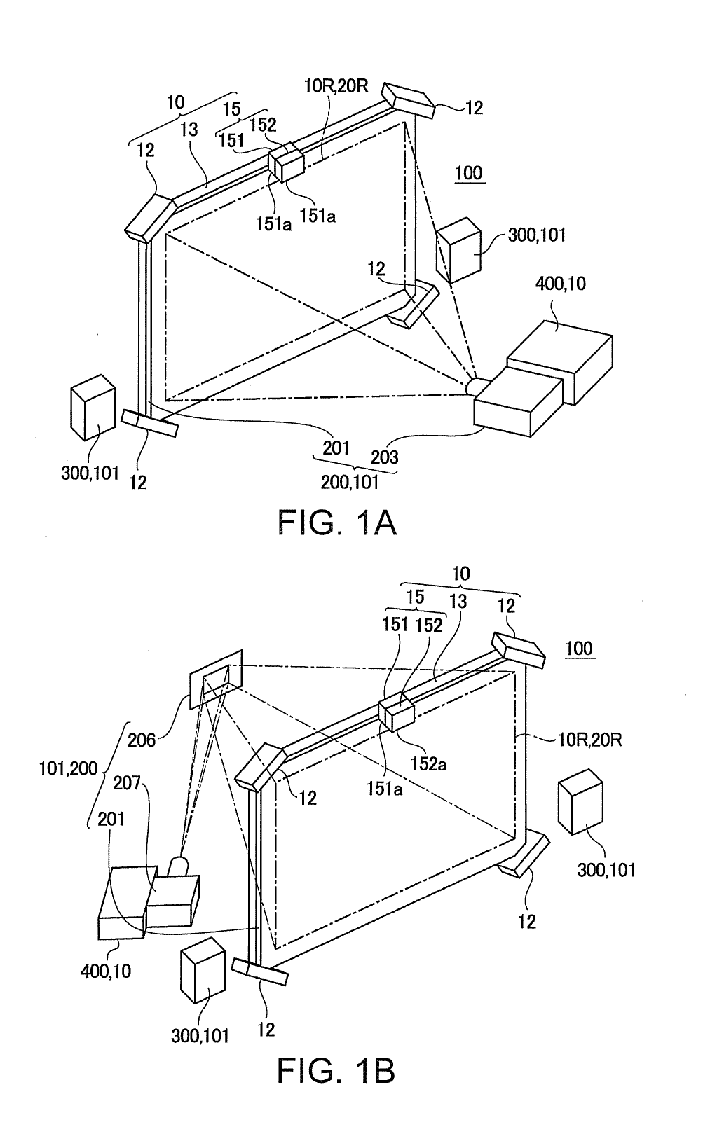

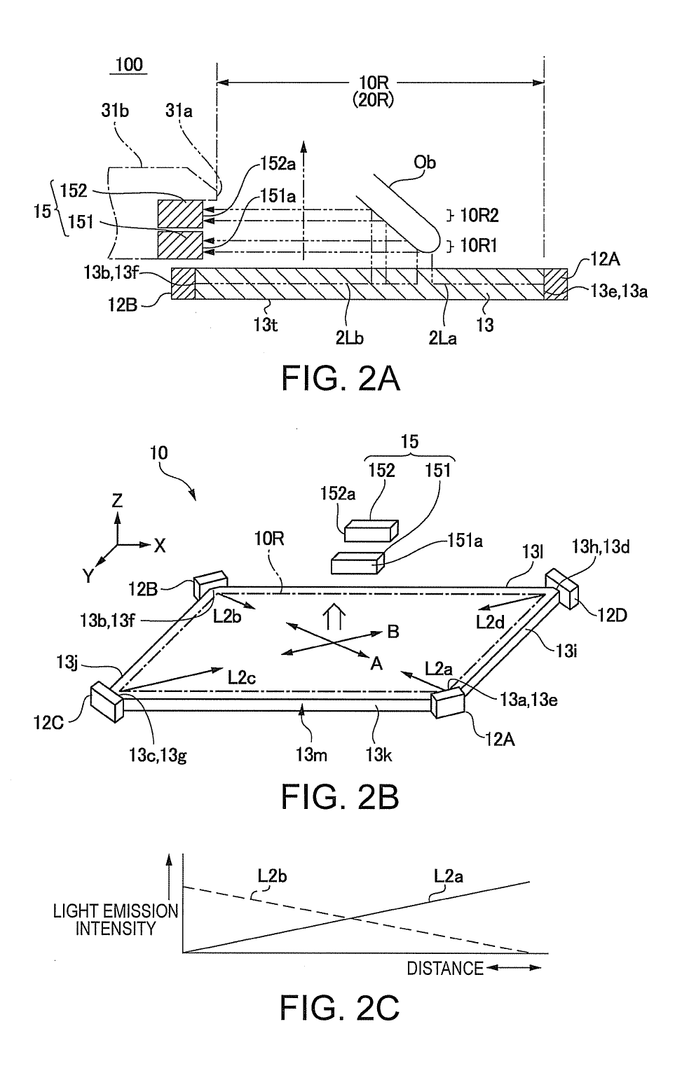

FIGS. 1A and 1B are explanatory diagrams schematically showing a configuration of an optical information input device and an electronic device with an optical input function equipped with the optical information input device, wherein FIG. 1A is an explanatory diagram showing a configuration example of the case of using a projection display device for projecting an image to an image projection surface from the front (the input operation side), and FIG. 1B is an explanatory diagram showing a configuration example of the case of using a projection display device for projecting an image to the image projection surface from the rear (the opposite side to the input operation side). FIGS. 2A through 2C are block diagrams showing a configuration of the optical information input device to which the invention is applied.

The electronic device 100 with an optical input function shown in FIGS. 1A and 1B is provided with an optical information input device 10 and an electronic device main body 101, and the electronic device main body 101 is provided with an image generation device 200 and a sound generation device 300. Further, the electronic device 100 with an optical input function is provided with a control device 400 common to the optical information input device 10 and an electronic device main body 101. Such an optical information input device 10 is arranged to detect the two-dimensional position and so on of an object matter Ob and then change the content of an image displayed by the image generation device 200, the content of a sound generated by the sound generation device 300, and so on when the object matter Ob, such as a finger, is moved closer to an input area 10R in accordance with the image displayed by the image generation device 200. In the present embodiment, the image generation device 200 is of a projection type, and has a screen-like projection target surface 201 disposed so as to overlap a light guide plate 13 on the input operation side thereof. Therefore, the image generation device 200 forms an image in an area overlapping the light guide plate 13 in a plan view. An image display area 20R in the present embodiment is an area substantially overlapping the input area 10R of the optical information input device 10.

The image generation device 200 of the electronic device 100 with an optical input function shown in FIG. 1A among the electronic devices 100 with an optical input function shown in FIGS. 1A and 1B is provided with a projection display device 203 for projecting an image from the front (on the input operation side). The image generation device 200 of the electronic device 100 with an optical input function shown in FIG. 1B is provided with a mirror 206 disposed on the rear side (the opposite side to the input operation side) of the light guide plate 13 and the projection target surface 201, and a projection display device 207 for projecting an image toward the mirror 206.

### Detailed Configuration of Optical Information Input Device 10

FIGS. 2A through 2C are explanatory diagrams showing a detailed configuration of the optical information input device to which the invention is applied, wherein FIG. 2A is an explanatory diagram schematically showing a cross-sectional configuration of the optical information input device, FIG. 2B is an explanatory diagram showing a configuration of the light guide plate and so on used for the optical information input device, and FIG. 2C is an explanatory diagram showing an attenuation condition of a position detection infrared light beam inside the light guide plate.

As shown in FIGS. 2A and 2B, in the optical information input device 10 according to the present embodiment, the light guide plate 13 has a rectangular or substantially rectangular planar shape. Therefore, the optical information input device 10 is provided with four position detection light source 12A through 12D which emit position detection light beams L2a through L2d (the position detection light sources 12 shown in FIGS. 1A and 1B), the light guide plate 13 having four light entrance sections 13a through 13d where the position detection light beams L2a through L2d enter disposed on a surrounding side end surface 13m, and a light receiving device 15. The light guide plate 13 has a light emitting surface 13s for emitting the position detection light beams L2a through L2d transmitting inside thereof on one surface (the upper surface in the drawing), and the light emitting surface 13s and the side end surface 13m are perpendicular to each other.

In the present embodiment, both of the four position detection light sources 12A through 12D and the four light entrance sections 13a through 13d are respectively disposed at positions corresponding to corners 13e, 13f, 13g, and 13h of the light guide plate 13. The light entrance sections 13a through 13d are each formed of, for example, an end surface formed by removing a corner portion of the light guide plate 13. The position detection light sources 12A through 12D are disposed so as to face the light entrance sections 13a through 13d, respectively, and are preferably disposed so as to have close contact with the light entrance sections 13a through 13d, respectively.

The light guide plate 13 is formed of a plate of transparent resin such as polycarbonate or acrylic resin. In the light guide plate 13, the light emitting surface 13s or the rear surface 13t on the opposite side to the light emitting surface 13s is provided with alight scattering structure such as a surface relief structure, a prism structure, or a scattering layer (not shown), and therefore, according to such a light scattering structure, the light entering the light entrance sections 13a through 13d and propagated inside thereof is gradually deflected and emitted from the light emitting surface 13s as the light proceeds along the propagation direction. It should be noted that in some cases an optical sheet such as a prism sheet or a light scattering plate is disposed on the light emitting side of the guide light plate 13 in order for achieving equalization of the position detection light beams L2a through L2d if necessary.

The position detection light sources 12A through 12D are each formed of a light emitting element such as a light emitting diode (LED), and respectively emit the position detection light beams L2a through L2d each made of an infrared light beam in accordance with a drive signal output from a drive circuit (not shown). Although not particularly limited, the types of the position detection light beams L2a through L2d are preferably different from the visible light in wavelength distribution or in light emission condition by applying modulation such as blinking. Further, the position detection light beams L2a through L2d preferably have wavelength band to be efficiently reflected by the object matter Ob such as a finger or a stylus pen. Therefore, if the object matter Ob is a human body such as a finger, the position detection light beams are preferably infrared light beams (in particular near infrared light beams near to the visible light area with a wavelength of, for example, around 850 nm or 950 nm) having high reflectance on a surface of a human body.

The number of the position detection light sources 12A through 12D is essentially plural, and the position detection light sources are configured so as to emit the position detection light beams from respective positions different from each other. Among the four position detection light sources 12A through 12D the position detection light sources at diagonal positions form a first light source as a pair of position detection light sources, and the other two position detection light sources form a second light source as a pair. Further, it is also possible that among the four position detection light sources 12A through 12D the two position detection light sources adjacent to each other form a first light source pair as a pair, and the other two position detection light sources form a second light source pair as a pair.

In the electronic device 100 with an optical input function thus configured, the position detection light beam L2a and the position detection light beam L2b are emitted from the light emitting surface 13s while being propagated inside the light guide plate 13 in the directions opposite to each other along the direction indicated by the arrow A. Further, the position detection light beam L2c and the position detection light beam L2d are emitted from the light emitting surface 13s while being propagated inside the light guide plate 13 in the directions opposed to each other along the direction (the direction indicated by the arrow B) traversing the direction indicated by the arrow A.

The input area 10R is a planar area where the position detection light beams L2a through L2d are emitted toward the viewing side (the operation side), and a planar area where a reflected light beam due to the object matter Ob can occur. In the present embodiment, the planar shape of the input area 10R is rectangular, and in the input area 10R, an internal angle of the corner portion between the adjacent sides is arranged to be the same as the internal angle of each of the corners 13e through 13h of the light guide plate 13, specifically 90°, for example.

In the optical information input device 10 with such a configuration, the light receiving device 15 is disposed at a position overlapping substantially the central portion in the length direction of a longer side portion (a side portion 131) among the side portions 13i, 13j, 13k, and 13l of the light guide plate 13.

In the present embodiment, the light receiving device 15 is provided with a first light detector 151 and a second light detector 152 distant from the first light detector 151 in the Z direction. Here, the first light detector 151 and the second light detector 152 are light detectors for detecting the positions of the object matter Ob in a first X-Y plane 10R1 and a second X-Y plane 10R2, respectively, each of which is an imaginary plane perpendicular to the direction (the Z direction) along which the position detection light beams are emitted from the light emitting surface 13s of the light guide plate 13, and are disposed so that the respective incident light axes are parallel to each other. In other words, a light receiving section 151a of the first light detector 151 faces to the first X-Y plane 10R1 closer to the light guide plate 13 of the input area 10R, and a light receiving section 152a of the second light detector 152 faces to the second X-Y plane 10R2 of the input area 10R on the opposite side of the first X-Y plane 10R1 to the light guide plate 13.

### Fundamental Principle

A method of detecting the position information of the object matter Ob based on the detection in the light receiving device 15 described above will be explained. Various types of methods of detecting the position information are possible, and as an example thereof, there can be cited a method of obtaining the ratio of attenuation coefficient between the light intensities of the two position detection light beams based on the ratio of the light intensity between the two position detection light beams, and then obtaining the propagation distances of the both position detection light beams based on the ratio of the attenuation coefficient, thereby obtaining the positional coordinate in a direction along a line connecting the two light sources corresponding to each other.

Firstly, in the electronic device 100 with an optical input function according to the present embodiment, the position detection light beams L2a through L2d emitted from the position detection light sources 12A through 12D enter the inside of the light guide plate 13 from the light entrance sections 13a through 13d, respectively, and then are gradually emitted from the light emitting surface 13s while being propagated inside the light guide plate 13. As a result, the position detection light beams L2a through L2d are emitted from the light emitting surface 13s in a planar manner.

For example, the position detection light beam L2a is gradually emitted from the light emitting surface 13s while being propagated inside the light guide plate 13 from the light entrance section 13a toward the light entrance section 13b. Similarly, the position detection light beams L2b through L2d are also emitted from the light emitting surface 13s gradually while being propagated inside the light guide plate 13. Therefore, when the object matter Ob such as a finger is disposed in the input area 10R, the object matter Ob reflects the position detection light beams L2a through L2d, and the light receiving device 15 detects some of the reflected light beams.

Here, it is conceivable that the light intensity of the position detection light beam L2a emitted to the input area 10R is linearly attenuated in accordance with the distance from the position detection light source 12A as illustrated with a solid line in FIG. 2C, and the light intensity of the position detection light beam L2b emitted to the input area 10R is linearly attenuated in accordance with the distance from the position detection light source 12B as illustrated with a dotted line in FIG. 2C.

Further, denoting the controlled variable (e.g., the amount of current), the conversion coefficient, and the intensity of the emitted light of the position detection light source 12A as Ia, k, and Ea, respectively, and the controlled variable (e.g., the amount of current), the conversion coefficient, and the intensity of the emitted light of the position detection light source 12B as Ib, k, and Eb, the following formulas can be obtained.

Ea=k·Ia

Eb=k·Ib

Further, denoting the attenuation coefficient and the detection light intensity of the position detection light beam L2a as fa and Ga, and the attenuation coefficient and the detection light intensity of the position detection light beam L2b as fb and Gb, the following formulas can be obtained.

Ga=fa·Ea=fa·k·Ia

Gb=fb·Eb=fb·k·Ib

Therefore, since the following formula can be obtained if it is assumed that the ratio Ga/Gb of the detection light intensity between the both position detection light beams can be detected in the light receiving device 15, if the values corresponding to the ratio Ea/Eb of the emitted light intensity and the ratio Ia/Ib of the controlled variable are known, the ratio fa/fb of the attenuation coefficient can be obtained.

Ga/Gb=(fa·Ea)/(fb·Eb)=(fa/fb)·(Ia/Ib)

If there is a linear relationship between the ratio of the attenuation coefficient and the ratio of the propagation distance of the both position detection light beams, the position information of the object matter Ob can be obtained by previously setting the linear relationship.

As a method of obtaining the ratio fa/fb of the attenuation coefficient described above, for example, the position detection light source 12A and the position detection light source 12B are blinked with respective phases reverse to each other (e.g., operated with rectangular or sinusoidal drive signals at a frequency with which the phase difference caused by a difference in propagation distance can be neglected, and having a phase difference of 180 degrees from each other), and then the waveform of the detection light intensity is analyzed. More realistically, for example, one Ia of the controlled variables is fixed (Ia=Im), the other Ib of the controlled variables is controlled so that the detection waveform cannot be observed, namely, the ratio Ga/Gb of the detection light intensity becomes one, and the ratio fa/fb of the attenuation coefficient is obtained in accordance with the controlled variable Ib=Im·(fa/fb) at this time.

Further, it is possible to perform control so that the sum of the both controlled variables is always constant, namely the following formula is satisfied.

Im=Ia+Ib

In this case, the following formula is obtained.

Ib=Im·fa/(fa+fb)

Therefore, assuming fa/(fa+fb)=α, according to the following formula, the ratio of the attenuation coefficient can be obtained.

fa/fb=α/(1−α)

Therefore, the position information of the object matter Ob along the direction of the arrow A can be detected by driving the position detection light source 12A and the position detection light source 12B with the respective phases reverse to each other. Further, the position information of the object matter Ob along the direction of the arrow B can be detected by driving the position detection light source 12C and the position detection light source 12D with the respective phases reverse to each other. Therefore, the positional coordinate of the object matter Ob on the X-Y plane can be detected by sequentially performing the detection operation in the A direction and the B direction described above in the control system.

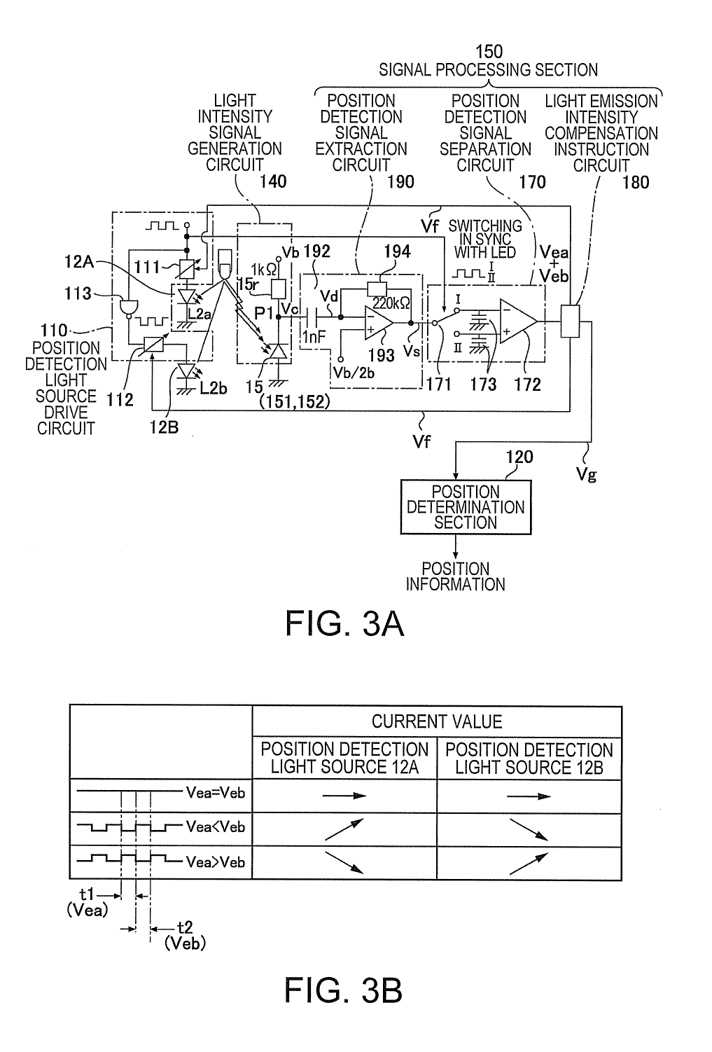

When detecting the two-dimensional position information of the object matter Ob in the input area 10R based on the light intensity ratio of the position detection light beams detected by the light receiving device 15 as described above, it is also possible to adopt a configuration of, for example, using a microprocessor unit (MPU) as a signal processing section, and thus, executing a predetermined software (an operation program) by the microprocessor unit, thereby performing the process. Further, as described later with reference to FIGS. 3A and 3B, it is also possible to adopt a configuration of performing the process with a signal processing section using hardware such as a logic circuit.

### Configuration Example of Signal Processing Section

FIGS. 3A and 3B are explanatory diagrams showing the content of the signal processing in the optical information input device 10 and the electronic device 100 with an optical input function to which the invention is applied, wherein FIG. 3A is an explanatory diagram of the signal processing section of the optical information input device 10 and the electronic device 100 with an optical input function to which the invention is applied, and FIG. 3B is an explanatory diagram showing the content of the processing in the light emission intensity compensation instruction section of the signal processing section.

As shown in FIG. 3A, in the optical information input device 10 and the electronic device 100 with an optical input function according to the present embodiment, a position detection light source drive circuit 110 applies a drive pulse to the position detection light source 12A via a variable resistor 111, and applies a drive pulse to the position detection light source 12B via an inverter circuit 113 and a variable resistor 112. Therefore, the position detection light source drive circuit 110 applies the drive pulses with phases reverse to each other to the position detection light source 12A and the position detection light source 12B to thereby modulate and then emit the position detection light beams L2a, L2b. Then, the position detection light beams L2a, L2b reflected by the object matter Ob is received by the first light detector 151 and the second light detector 152 of the light receiving device 15. In a light intensity signal generation circuit 140, a resistor 15r of about 1 kΩ is electrically connected in series to the first light detector 151 and the second light detector 152 of the light receiving device 15, and a bias voltage Vb is applied to both ends thereof.

In such a light intensity signal generation circuit 140, a signal processing section 150 is electrically connected to a connection point P1 of the first and second light detectors 151, 152 of the light receiving device 15 and the resistor 15r. A detection signal Vc output from the connection point P1 of the first and second light detectors 151, 152 of the light receiving device 15 and the resistor 15r is expressed by the following formula.

Vc=V15/(V15+resistance value of the resistor 15r)

V15: an equivalent resistance of the light receiving device 15

Therefore, in comparison between the case in which the environment light does not enter the light receiving device 15 and the case in which the environment light enters the light receiving device 15, the level and the amplitude of the detection signal Vc become greater in the case in which the environment light enters the light receiving device 15.

The signal processing section 150 is substantially composed of a position detection signal extraction circuit 190, a position detection signal separation circuit 170, and the light emission intensity compensation instruction circuit 180.

The position detection signal extraction circuit 190 is provided with a filter 192 formed of a capacitor of about 1 nF, and the filter 192 functions as a high-pass filter for removing a direct-current component from the signal output from the connection point P1 of the light receiving device 15 and the resistor 15r. Therefore, due to the filter 192, the position detection signal Vd of the position detection light beams L2a, L2b detected by the light receiving device 15 can be extracted from the detection signal Vc output from the connection point P1 of the light receiving device 15 and the resistor 15r. Therefore, since the intensity of the environment light can be regarded as constant during a certain period of time while the position detection light beams L2a, L2b are modulated, the low-frequency component or the direct-current component caused by the environment light can be removed by the filter 192.

Further, the position detection signal extraction circuit 190 has an adder circuit 193 provided with a feedback resistor 194 of about 220 kΩ in the posterior stage of the filter 192, and the position detection signal Vd extracted by the filter 192 is output to the position detection signal separation circuit 170 as a position detection signal Vs obtained by superimposing the position detection signal Vd into a voltage V/2 half as large as the bias voltage Vb.

The position detection signal separation circuit 170 is provided with a switch 171 for performing a switching operation in sync with the drive pulse applied to the position detection light source 12A, a comparator 172, and capacitors 173 electrically connected respectively to input lines of the comparator 172. Therefore, when the position detection signal Vs is input to the position detection signal separation circuit 170, the position detection signal separation circuit 170 outputs the effective value Vea of the position detection signal Vs during the period in which the position detection light beam L2a is ON and the effective value Veb of the position detection signal Vs during the period in which the position detection light beam L2b is ON alternately to the light emission intensity compensation instruction circuit 180.

The light emission intensity compensation instruction circuit 180 compares the effective values Vea, Veb with each other to perform the process shown in FIG. 3B, and then outputs a control signal Vf to the position detection light source drive circuit 110 so that the effective value Vea of the position detection signal Vs during the period in which the position detection light beam L2a is ON and the effective value Veb of the position detection signal Vs during the period in which the position detection light beam L2b is ON become in the same level. In other words, the light emission intensity compensation instruction circuit 180 compares the effective value Vea of the position detection signal Vs during the period in which the position detection light beam L2a is ON and the effective value Veb of the position detection signal Vs during the period in which the position detection light beam L2b is ON with each other, and keeps the present drive conditions to the position detection light sources 12A, 12B if they are equal to each other. In contrast thereto, if the effective value Vea of the position detection signal Vs during the period in which the position detection light beam L2a is ON is lower than the effective value Veb of the position detection signal Vs during the period in which the position detection light beam L2b is ON, the light emission intensity compensation instruction circuit 180 makes the resistance value of the variable resistor 111 decrease to thereby increase the light emission intensity of the position detection light source 12A. Further, if the effective value Veb of the position detection signal Vs during the period in which the position detection light beam L2b is ON is lower than the effective value Vea of the position detection signal Vs during the period in which the position detection light beam L2a is ON, the light emission intensity compensation instruction circuit 180 makes the resistance value of the variable resistor 112 decrease to thereby increase the light emission intensity of the position detection light source 12B.

In such a manner as described above, in the optical information input device 10 and the electronic device 100 with an optical input function, the light emission intensity compensation instruction circuit 180 of the signal processing section 150 controls the controlled variables (the amount of the current) of the position detection light sources 12A, 12B so that the detection values of the position detection light beams L2a, L2b by the light receiving device 15 become equal to each other. Therefore, since there exists in the light emission intensity compensation instruction circuit 180 the information regarding the controlled variables of the position detection light sources 12A, 12B with which the effective value Vea of the position detection signal Vs during the period in which the position detection light beam L2a is ON and the effective value Veb of the position detection signal Vs during the period in which the position detection light beam L2b is ON become in the same level, by outputting the information to a position determination section 120 as the position detection signal Vg, the position determination section 120 can obtain the positional coordinate of the object matter Ob in the input area 10R along the direction of the arrow A. Further, by applying the same principle, the positional coordinate of the object matter Ob in the input area 10R along the direction of the arrow B can be obtained. Therefore, the positional coordinate of the object matter Ob on the X-Y plane can be detected.

Further, in the present embodiment, the filter 192 removes the direct-current component caused by the environment light from the detection signal Vc output from the connection point P1 of the light receiving device 15 and the resistor 15r to thereby extract the position detection signal Vd in the position detection signal extraction circuit 190. Therefore, even in the case in which the detection signal Vc output from the connection point P1 of the light receiving device 15 and the resistor 15r includes the signal component due to the infrared component of the environment light, the influence of such environment light can be canceled.

### Another Position Detection Method

In the optical information input device 10 according to the present embodiment, it is also possible to drive the position detection light sources 12A, 12D in-phase, and the position detection light sources 12B, 12C in-phase but reverse to the phase with which the position detection light sources 12A, 12D are driven, thereby generating the position detection light beams used for detecting the position in the first direction (the X direction). On this occasion, it is also possible to drive at different timing the position detection light sources 12A, 12C in-phase, and the position detection light sources 12B, 12D in-phase but reverse to the phase with which the position detection light sources 12A, 12C are driven, thereby generating the position detection light beams used for detecting the position in the second direction (the Y direction). Also by using the method described above, the positional coordinate of the object matter Ob on the X-Y plane can be detected. According to such a configuration of lighting a plurality of position detection light sources simultaneously as described above, since the light-dark skewed distribution of the position detection light beam can preferably be obtained in a range broader than that of the configuration of lighting a single position detection light source, for example, more accurate position detection becomes possible.

### Configuration of Control System and So On

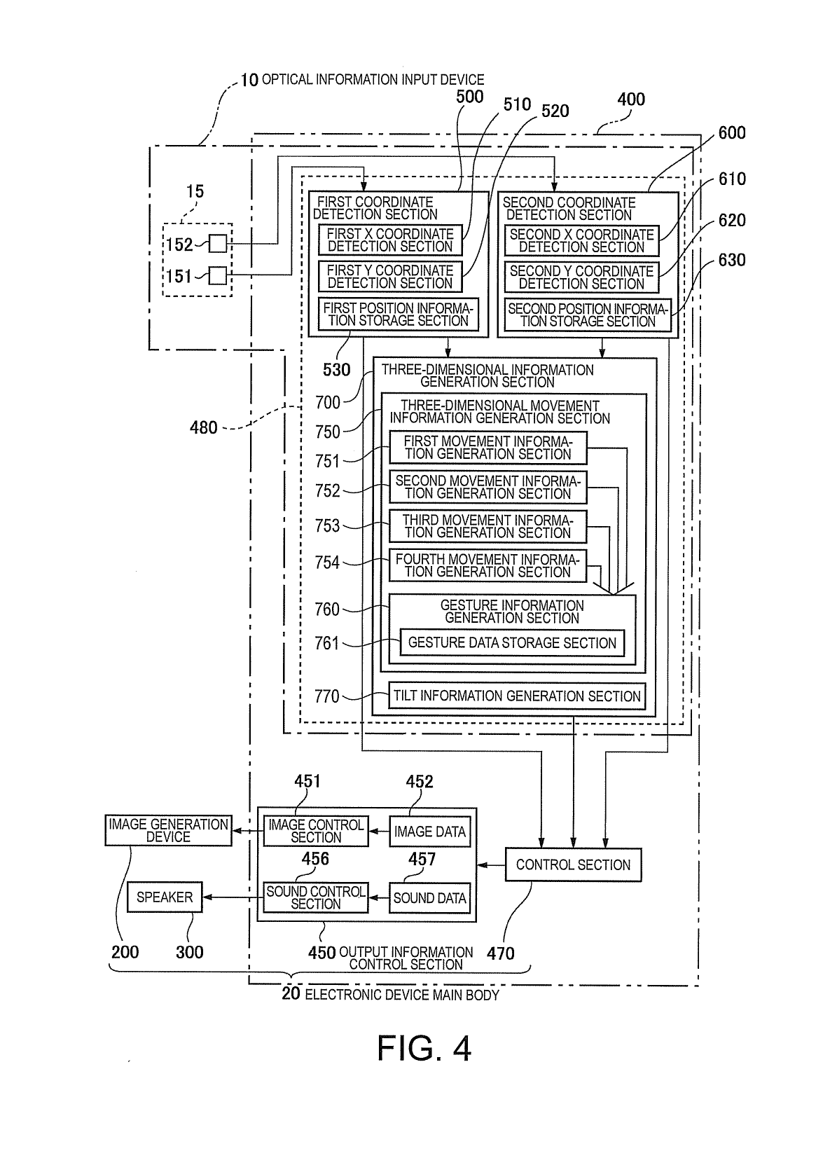

FIG. 4 is an explanatory diagram of a control system and so on of the optical information input device to which the invention is applied. As shown in FIG. 4, the optical information input device 10 according to the present embodiment is configured as a touch panel for detecting the position detection light beams reflected by the object matter Ob such as a finger with the first light detector 151 of the light receiving device 15 when the object matter Ob comes closer to an image of, for example, a switch displayed in the image display area 20R. Therefore, as shown in FIG. 4, the optical information input device 10 according to the present embodiment is provided with a first coordinate detection section 500, which detects a first coordinate corresponding to the position of the object matter Ob in the first X-Y plane 10R1 based on the detection result in the first light detector 151, in a data processing section 480 in a control device 400. Such a first coordinate detection section 500 as described above is provided with the signal processing section 150 explained above with reference to FIGS. 3A and 3B. The first coordinate detection section 500 is provided with a first X coordinate detection section 510 for detecting the X coordinate position of the object matter Ob in the first X-Y plane 10R1 and a first Y coordinate detection section 520 for detecting the Y coordinate position of the object matter Ob in the first X-Y plane 10R1, and detects the X coordinate position of the object matter Ob in the first X-Y plane 10R1 and the Y coordinate position of the object matter Ob in the first X-Y plane 10R1 as the first coordinate to output the first coordinate to a superordinate control section 470.

Further, the optical information input device 10 according to the present embodiment generates a three-dimensional state of the object matter Ob in the input area 10R as three-dimensional information. Therefore, the optical information input device 10 is firstly provided with a second coordinate detection section 600, which detects a second coordinate corresponding to the position of the object matter Ob in the second X-Y plane 10R2 based on the detection result in the second light detector 152, in the data processing section 480 in the control device 400. Such a second coordinate detection section 600 as described above is provided with the signal processing section 150 explained above with reference to FIGS. 3A and 3B. it should be noted that in the case of performing the operations of the first coordinate detection section 500 and the second coordinate detection section 600 at timing different to each other, the signal processing section 150 can be used commonly by the first coordinate detection section 500 and the second coordinate detection section 600. Similarly to the first coordinate detection section 500, the second coordinate detection section 600 is provided with a second X coordinate detection section 610 for detecting the X coordinate position of the object matter Ob in the second X-Y plane 10R2 and a second Y coordinate detection section 620 for detecting the Y coordinate position of the object matter Ob in the second X-Y plane 10R2, and detects the X coordinate position of the object matter Ob in the second X-Y plane 10R2 and the Y coordinate position of the object matter Ob in the second X-Y plane 10R2 as the second coordinate to output the second coordinate to the superordinate control section 470. Further, the first coordinate detection section 500 and the second coordinate detection section 600 are provided with a first position information storage section 530 and a second position information storage section 630 for temporarily storing the first coordinate and the second coordinate together with time information, respectively.

Further, the optical information input device 10 according to the present embodiment is provided with a three-dimensional information generation section 700 for generating three-dimensional information of the object matter Ob based on the first coordinate and the second coordinate. In the present embodiment, the three-dimensional information generation section 700 is provided with a three-dimensional movement information generation section 750 for generating three-dimensional movement information corresponding to a motion of the object matter Ob as three-dimensional information based on the temporal change in the first coordinate and temporal change in the second coordinate, and a tilt information generation section 770 for generating tilt information corresponding to a tilt of the object matter Ob in the input area 10R as the three-dimensional information based on the first coordinate and the second coordinate.

Here, the three-dimensional movement information generation section 750 is provided with a first movement information generation section 751 for generating first movement information corresponding to the movement of the object matter Ob in the first X-Y plane 10R1 as the three-dimensional movement information, and a second movement information generation section 752 for generating second movement information corresponding to the movement of the object matter Ob in the second X-Y plane 10R2 as the three-dimensional movement information. Further, the three-dimensional movement information generation section 750 is provided with a third movement information generation section 753 for generating third movement information corresponding to a movement direction in the case in which the object matter Ob moves in the Z direction as the three-dimensional movement information, and a fourth movement information generation section 754 for generating fourth movement information corresponding to the change in the tilt of the object matter Ob in the input area 10R as the three-dimensional movement information.

Further, the three-dimensional movement information generation section 750 is provided with a gesture information generation section 760 for specifying the motion of the object matter Ob as one of a plurality of gesture patterns based on the three-dimensional movement information to generate gesture information corresponding to the motion of the object matter Ob. In the present embodiment, when generating the gesture information corresponding to the motion of the object matter Ob, the gesture information generation section 760 compares the respective three-dimensional movement information (the first movement information, the second movement information, the third movement information, and the fourth movement information) generated in the first movement information generation section 751, the second movement information generation section 752, the third movement information generation section 753, and the fourth movement information generation section 754 with data stored in a gesture data storage section 761 to specify which one of the plurality of gesture patterns corresponds to the present motion of the object matter Ob, thereby generating the gesture information.

In the optical information input device 10 configured in such a manner as described above, a configuration of performing a process described later can be adopted for the first coordinate detection section 500, the second coordinate detection section 600, and the three-dimensional information generation section 700 by using a microprocessor unit (MPU) and executing predetermined software (an operation program) with the MPU. Further, it is also possible to adopt a configuration of performing the process described later using hardware such as a logic circuit for the first coordinate detection section 500, the second coordinate detection section 600, and the three-dimensional information generation section 700.

The electronic device main body 20 has an output information control section 450 and the superordinate control section 470 disposed inside the control device 400. The output information control section 450 is provided with an image control section 451 for outputting predetermined image data 452 to an image generation device 200 of the electronic device 100 with an optical input function based on the condition designated via the superordinate control section 470. Further, the output information control section 450 is provided with a sound control section 456 for outputting predetermined sound data 457 to a sound generation device 300 of the electronic device 100 with an optical input function based on the condition designated via the superordinate control section 470.

It should be noted that although in the present embodiment the first coordinate detection section 500, the second coordinate detection section 600, and the three-dimensional information generation section 700 of the optical information input device 10 are configured commonly in the control device 400 together with the output information control section 450 and so on of the electronic device main body 20, it is also possible to configure the first coordinate detection section 500, the second coordinate detection section 600, and the three-dimensional information generation section 700 in a separate control device from the output information control section 450 of the electronic device main body 20.

### Method of Generating Three-Dimensional Information and So On

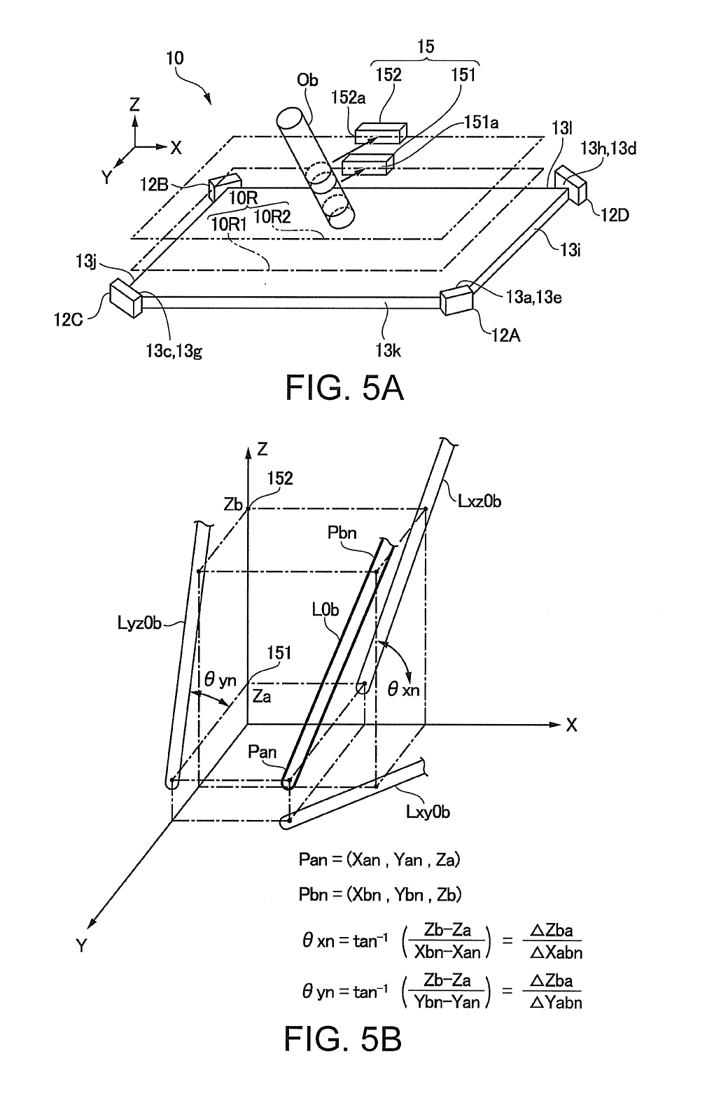

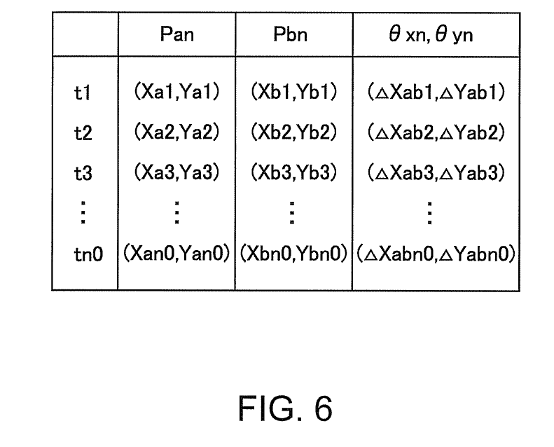

FIGS. 5A and 5B are explanatory diagrams showing a method of detecting a three-dimensional motion of the object matter Ob in the optical information input device 10 and the electronic device 100 with an optical input function to which the invention is applied, wherein FIG. 5A is an explanatory diagram showing a condition of receiving the position detection light beam with the light receiving device 15, and FIG. 5B is an explanatory diagram of the coordinate position of the object matter Ob. It should be noted that in FIG. 5B, the object matter Ob is illustrated with a thick solid line LOb, and the conditions of projecting the object matter Ob on the X-Y plane, the X-Z plane, and the Y-Z plane are illustrated with thin solid lines LxyOb, LxzOb, and LyzOb, respectively. FIG. 6 is an explanatory diagram of coordinates and tilts of the object matter Ob in the optical information input device 10 and the electronic device 100 with an optical input function, to which the invention is applied.

As shown in FIG. 5A, in the light receiving device 15 according to the present embodiment, the light receiving section 151a of the first light detector 151 faces to the first X-Y plane 10R1 closer to the light guide plate 13 of the input area 10R, and the light receiving section 152a of the second light detector 152 faces to the second X-Y plane 10R2 of the input area 10R on the opposite side of the first X-Y plane 10R1 to the light guide plate 13. Therefore, the first coordinate detection section 500 can detect the first coordinate of the object matter Ob in the first X-Y plane 10R1 based on the detection result in the first light detector 151. Further, the second coordinate detection section 600 can detect the second coordinate of the object matter Ob in the second X-Y plane 10R2 based on the detection result in the second light detector 152.

Here, the first light detector 151 is fixed at the position expressed by the following formula in the Z direction.

(Z-axis coordinate)=Za

Therefore, as shown in FIGS. 5B and 6, the three-dimensional coordinate Pan (the first coordinate) of the object Ob in the first X-Y plane 10R1 detected by the first coordinate detection section 500 is expressed by the following formula.

Pan=(Xan,Yan,Za)

wherein “n” denotes arbitrary time.

Further, the second light detector 152 is fixed at the position expressed by the following formula in the Z direction.

(Z-axis coordinate)=Zb

Therefore, the three-dimensional coordinate Pbn (the second coordinate) of the object Ob in the second X-Y plane 10R2 detected by the second coordinate detection section 600 is expressed by the following formula.

Pbn=(Xbn,Ybn,Zb)

wherein “n” denotes arbitrary time.

Therefore, the three-dimensional information generation section 700 can generate the three-dimensional information of the object matter Ob using the coordinates Pan, Pbn (a three-dimensional information generation process).

Further, by monitoring the coordinate Pan at each time point, the first movement information generation section 751 of the three-dimensional movement information generation section 750 can generate the first movement information corresponding to the movement of the object matter Ob in the first X-Y plane 10R1. Further, by monitoring the coordinate Pbn at each time point, the second movement information generation section 752 of the three-dimensional movement information generation section 750 can generate the second movement information corresponding to the movement of the object matter Ob in the second X-Y plane 10R2.

Further, if there are known the three-dimensional coordinates Pan, Pbn when the object matter Ob appears on the first X-Y plane 10R1, and then appears on the second X-Y plane 10R2, the direction along which the object matter Ob enters the input area 10R can be obtained. Therefore, in the three-dimensional movement information generation section 750, the third movement information generation section 753 can generate the third movement information corresponding to the direction of the movement when the object matter Ob moves in the Z direction so as to enter the input area 10R. Further, if there are known the three-dimensional coordinates Pan, Pbn during the period from when the object matter Ob appears on the first X-Y plane 10R1 and the second X-Y plane 10R2 to when the object matter Ob firstly leaves the first X-Y plane 10R1 and then leaves the second X-Y plane 10R2, the direction along which the object matter Ob leaves the input area 10R can be obtained. Therefore, in the three-dimensional movement information generation section 750, the third movement information generation section 753 can generate the third movement information corresponding to the direction of the movement when the object matter Ob moves in the Z direction so as to leave the input area 10R.

Further, when projecting the object matter Ob at arbitrary time n on the X-Z plane, the angle θ×n between the object matter Ob and the X-axis is expressed by the following formula, which is a function of ΔXabn=Xbn−Xan.

θ×n=tan⁻¹((Zb−Za)/(Xbn−Xan))

Further, when projecting the object matter Ob at arbitrary time n on the X-Y plane, the angle θyn between the object matter Ob and the Y-axis is expressed by the following formula, which is a function of ΔYabn=Ybn−Yan.

θyn=tan⁻¹((Zb−Za)/(Ybn−Yan))

Therefore, the tilt information generation section 770 can generate the tilt information (θxn,θyn) corresponding to the tilt of the object matter Ob in the input area 10R as the three-dimensional information.

Further, by obtaining the tilt information (θxn,θyn) at each time (n=1, 2, 3, . . . , n₀), and then monitoring the temporal variation thereof, the fourth movement information generation section 754 in the three-dimensional movement information generation section 750 can generate the fourth movement information corresponding to the variation in the tilt of the object matter Ob as the three-dimensional movement information.

Therefore, by comparing at least one of the movement information (the first movement information, the second movement information, the third movement information, and the fourth movement information) respectively generated by the first movement information generation section 751, the second movement information generation section 752, the third movement information generation section 753, and the fourth movement information generation section 754 with the data stored in the gesture data storage section 761, the gesture information generation section 760 in the three-dimensional movement information generation section 750 can specify which one of the plurality of gesture patterns corresponds to the present motion of the object matter Ob to thereby generate the gesture information.

It should be noted that regarding the tilt of the object matter Ob in the input area 10R, it is also possible to obtain the angle between the object matter Ob and the first X-Y plane 10R1 or the second X-Y plane 10R2, and use the angle as the tilt information.

### Input Example Using Gesture Information and Tilt Information

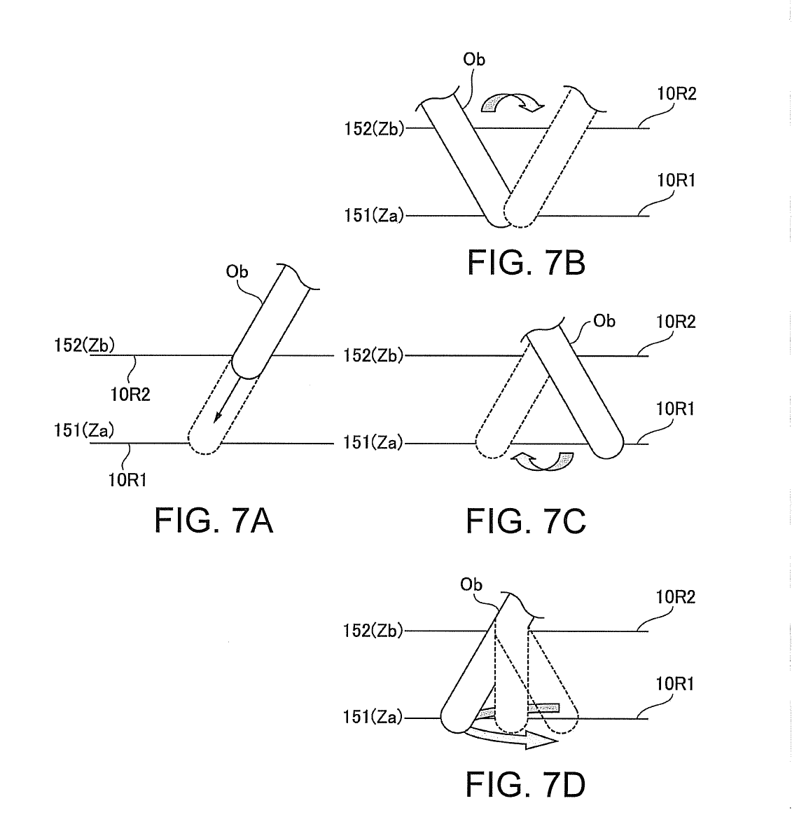

FIGS. 7A through 7D are explanatory diagrams showing the three-dimensional motion of the object matter used for the input in the optical information input device 10 and the electronic device 100 with an optical input function, to which the invention is applied.

Here, the three-dimensional motion of the object matter Ob used for the input denotes a movement of the object matter Ob in the X-Y plane (in the first X-Y plane 10R1 or the second X-Y plane 10R2), a movement of the object matter Ob in the Z direction, a tilt of the object matter Ob, a variation in the tilt of the object matter Ob, or a motion obtained by arbitrarily combining the these movements.

For example, in the electronic device 100 with an optical input function, when the image generation device 200 performs scroll display of an image, if the gesture information generation section 760 outputs to the control section 470 the gesture information denoting that the object matter Ob comes closer toward the image display area 20R while keeping the posture tilted at a predetermined angle as shown in FIG. 7A, the control section 470 performs control for increasing the scroll speed. In contrast, if the gesture information generation section 760 outputs to the control section 470 the gesture information denoting that the object matter Ob is distant from the image display area 20R while keeping the posture tilted at a predetermined angle, the control section 470 performs control for decreasing the scroll speed.

Further, in the electronic device 100 with an optical input function, when the image generation device 200 displays an image, if the gesture information generation section 760 outputs to the control section 470 the gesture information denoting that the tip portion of the object matter Ob is fixed and the base side thereof tilts from one side to the other side as shown in FIG. 7B, the control section 470 performs the control for enlarging the image. In contrast, if the gesture information generation section 760 outputs to the control section 470 the gesture information denoting that the tip portion of the object matter Ob is fixed and the base side thereof tilts from the other side to the one side, the control section 470 performs the control for shrinking the image.

Further, in the electronic device 100 with an optical input function, when the image generation device 200 displays a menu image, if the gesture information generation section 760 outputs to the control section 470 the gesture information denoting that the base side of the object matter Ob is fixed and the tip side thereof moves from one side to the other side as shown in FIG. 7C, the control section 470 performs the control for feeding the menu forward. In contrast, if the gesture information generation section 760 outputs to the control section 470 the gesture information denoting that the base side of the object matter Ob is fixed and the tip side thereof moves from the other side to the one side, the control section 470 performs the control for feeding the menu backward.

Further, in the electronic device 100 with an optical input function, when the sound generation device 300 plays back music, if the gesture information generation section 760 outputs to the control section 470 the gesture information denoting that the base side of the object matter Ob is fixed and the tip side thereof turns in one direction as shown in FIG. 7D, the control section 470 performs the control for increasing the volume. In contrast, if the gesture information generation section 760 outputs to the control section 470 the gesture information denoting that the base side of the object matter Ob is fixed and the tip side thereof turns in the other direction, the control section 470 performs the control for decreasing the volume.

Further, it is also possible to make a forecast of the menu in accordance with the tilt information (the angle of the object matter Ob) generated by the tilt information generation section 770 to thereby reduce the time for the user to execute the command.

### Major Advantages of Present Embodiment

As explained hereinabove, in the optical information input device 10 and the electronic device 100 with an optical input function according to the present embodiment, when the position detection light beams L2a through L2d are emitted from the light emitting surface 13s of the light guide plate 13, and the position detection light beams L2a through L2d are reflected by the object matter Ob disposed on the emission side of the light guide plate 13, the reflected light beams are detected by the light receiving device 15. Further, when the position detection light beams L2a through L2d are emitted from the light emitting surface 13s of the light guide plate 13, and the position detection light beams L2a through L2d are reflected by the object matter Ob disposed on the emission side of the light guide plate 13, the reflected light beams are detected by the light receiving device 15. Here, since the intensities of the position detection light beams L2a through L2d in the input area 10R and the distances from the position detection light sources 12A through 12D respectively have predetermined correlativity, it is possible to detect the position of the object matter Ob based on the received light intensity obtained via the light receiving device 15. Therefore, it is possible to perform input without using a particular stylus as the object matter.

Further, in the optical information input device 10 and the electronic device 100 with an optical input function according to the present embodiment, the light receiving device 15 is provided with the first light detector 151 and the second light detector 152 at the respective positions distant from each other in the Z direction. Therefore, it is possible to receive the position detection light beam reflected by the object matter Ob in the first X-Y plane 10R1 and the position detection light beam reflected by the object matter Ob in the second X-Y plane 10R2. Therefore, it is possible to obtain the position of the object matter Ob in the first X-Y plane 10R1 and the position of the object matter Ob in the second X-Y plane 10R2, and at the same time, obtain the three-dimensional information of the object matter Ob by obtaining the relative positional relationship between these positions. Therefore, the three-dimensional information of the object matter Ob can be used as the input information.

Further, it is possible to generate the information corresponding to the three-dimensional motion of the object matter Ob based on the temporal variation of the light receiving result in the light receiving device 15. In other words, since the temporal variations of the light receiving results of the position detection light beam reflected by the object matter Ob in the first X-Y plane 10R1 and the position detection light beam reflected by the object matter Ob in the second X-Y plane 10R2 correspond to the three-dimensional motion of the object matter Ob, the information corresponding to the three-dimensional motion of the object matter Ob can be generated. Therefore, it is possible to perform input of the information by the motion of the object matter Ob, which have never happened before. Moreover, since the three-dimensional motion of the object matter Ob is used, it is possible to perform various types of input with a single object matter Ob, and therefore, it is possible to perform input only with one hand, for example.

Further, in the present embodiment, the three-dimensional information generation section 700 is provided with a gesture information generation section 760 for specifying the motion of the object matter Ob as one of a plurality of gesture patterns based on the three-dimensional movement information to generate gesture information. Therefore, since it is possible to output the motion of the object matter Ob after converting it into the gesture information, by previously correlating the gesture information and the input information with each other, the input by gestures can easily be performed.

### Other Embodiments

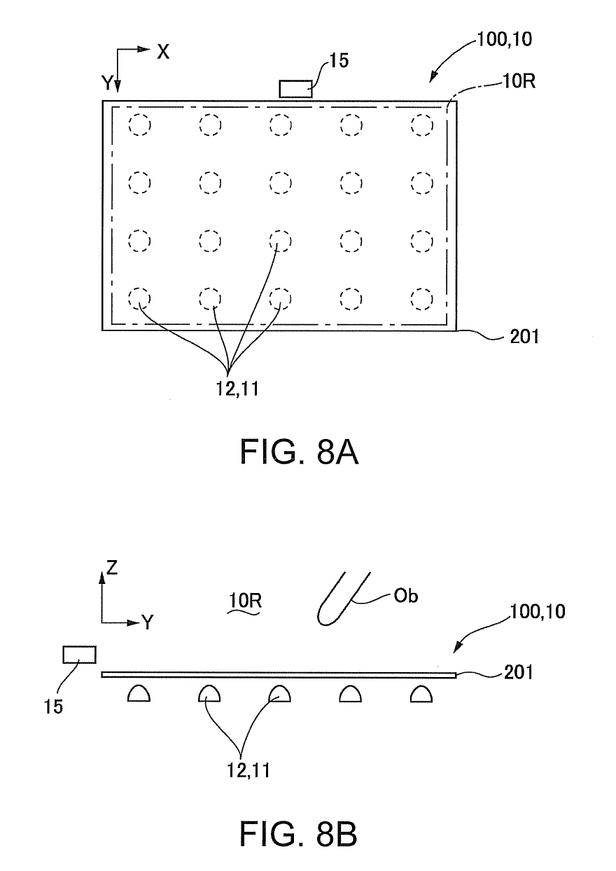

FIGS. 8A and 8B are explanatory diagrams showing a modified example of an optical position detection device 10 to which the invention is applied.

Although in the embodiment described above the light guide plate 13 is used, in the case of a display device (the electronic device) 100 with an optical input function, as shown in FIGS. 8A and 8B, it is also possible to adopt a position detection light source device 11 having a configuration of arranging a plurality of position detection light sources 12 at positions opposed to the detection area 10R in the Z-axis direction on the rear surface side of a screen-like projection target surface 201.

In the case of the configuration described above, by lighting either one of the position detection light sources 12 distant from each other in the X direction among the plurality of position detection light sources 12 when detecting the X coordinate position of the object matter Ob, the intensity distribution of the position detection light beam can be formed. Further, by lighting either one of the position detection light sources 12 distant from each other in the Y direction among the plurality of position detection light sources 12 when detecting the Y coordinate position of the object matter Ob, the intensity distribution of the position detection light beam can be formed.

Modified Example of Electronic Device 100 with Optical Input Function

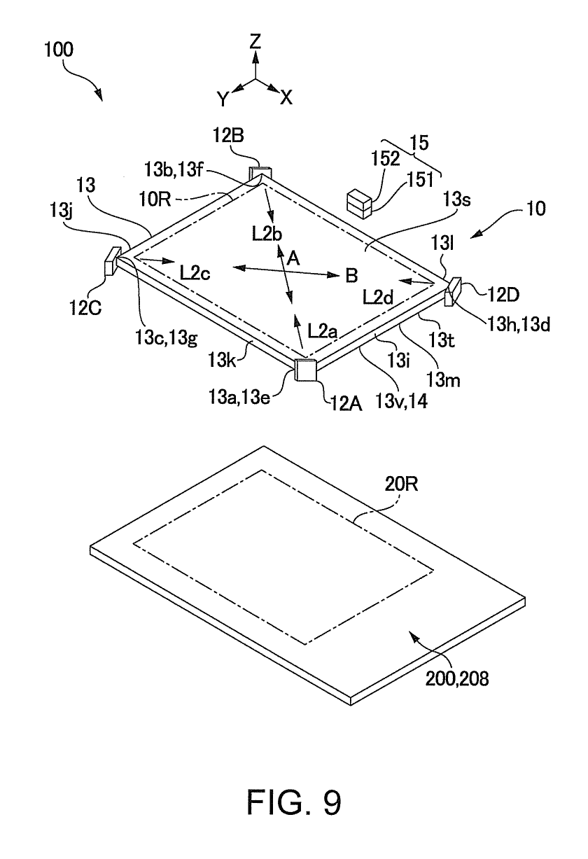

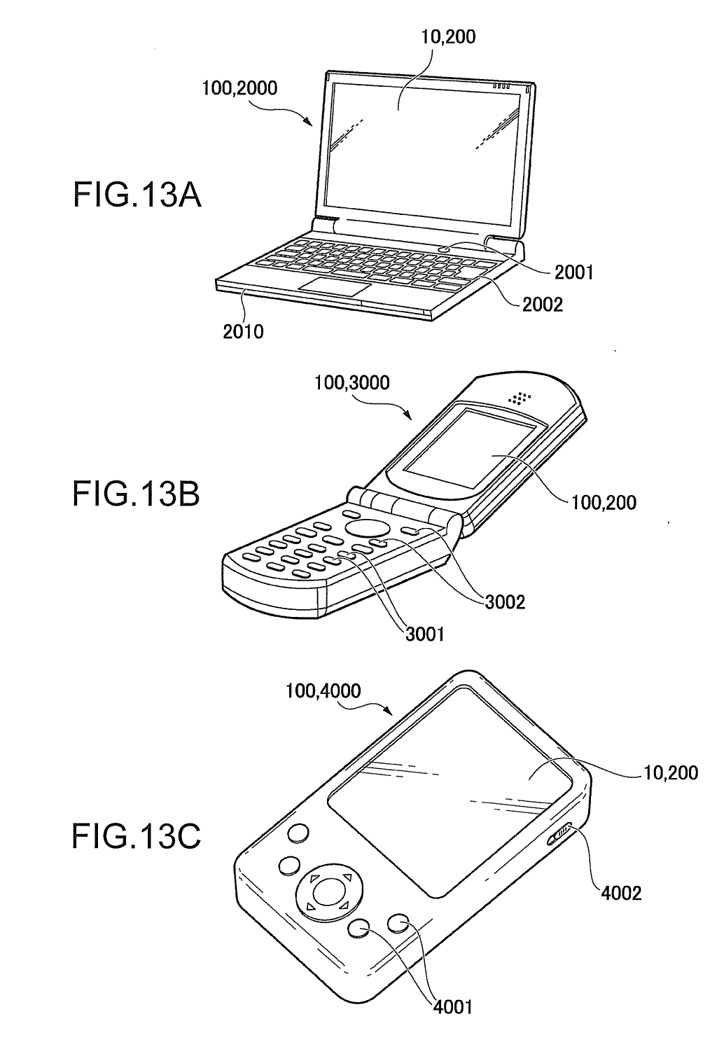

Although in the embodiment described above there is adopted the configuration of providing the projection display devices 203, 207 as the image generation device 200, by adopting a direct view display device as the image generation device 200 as shown in FIGS. 9 through 12, it can be used for the electronic devices described later with reference to FIGS. 13A through 13C.

First Modified Example of Electronic Device 100 with Optical Input Function

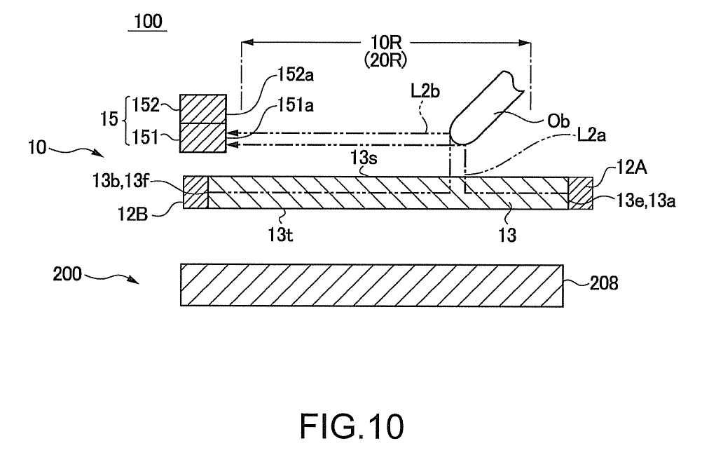

FIG. 9 is an exploded perspective view of the optical information input device 10 and the electronic device 100 with an optical input function according to the first modified example of the invention, and FIG. 10 is an explanatory diagram showing a cross-sectional configuration thereof. It should be noted that in the electronic device 100 with an optical input function according to the present example, since the configuration of the optical information input device 10 is substantially the same as in the embodiment described above, the constituents common to the embodiment are denoted with the same reference symbols, and the explanation therefor will be omitted.

The electronic device 100 with an optical input function shown in FIGS. 9 and 10 is provided with the optical information input device 10 and the image generation device 200, and the optical information input device 10 is provided with the position detection light sources 12 for emitting the position detection light beams, the light guide plate 13, and the light receiving device 15. The image generation device 200 is a direct view display device 208 such as an organic electroluminescence device or a plasma display device, and is disposed on the opposite side of the optical information input device 10 to the input operation side. The direct view display device 208 is provided with an image display area 20R in a region overlapping the light guide plate 13 in a plan view, and the image display area 20R overlaps the input area 10R in a plan view.

Second Modified Example of Electronic Device 100 with Optical Input Function

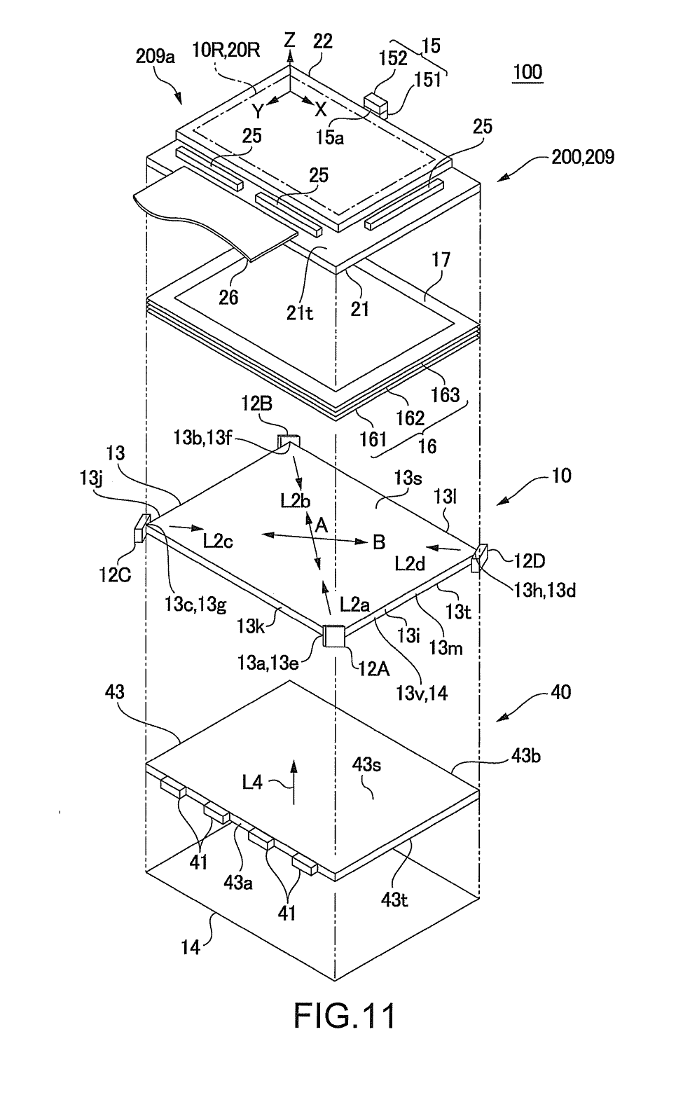

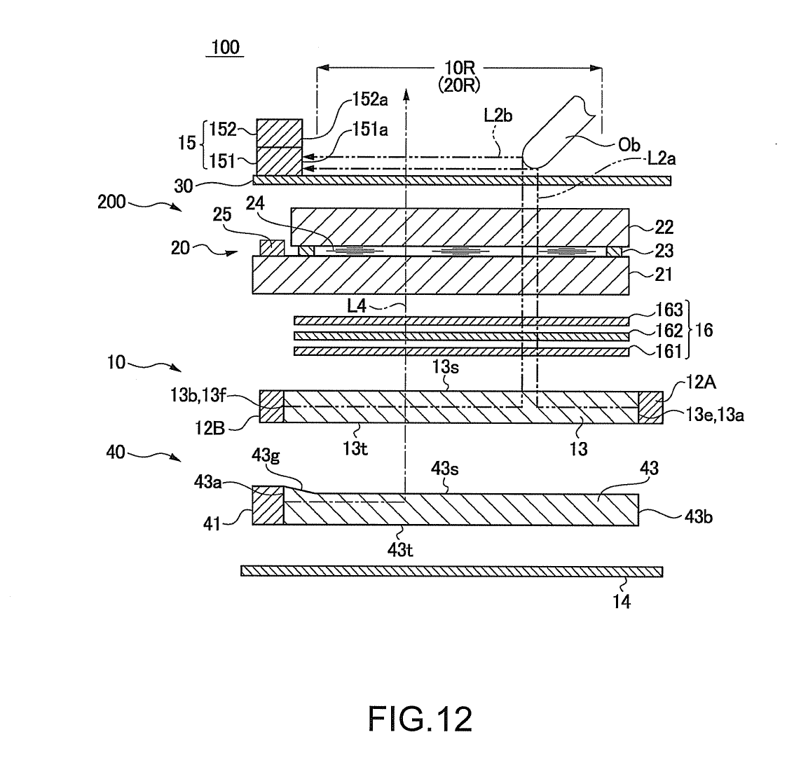

FIGS. 11 and 12 are explanatory diagrams of the optical information input device 10 and the electronic device 100 with an optical input function according to the second modified example of the invention, wherein FIG. 11 is an exploded perspective view of the optical information input device 10 and the electronic device 100 with an optical input function and FIG. 12 is an explanatory diagram showing a cross-sectional configuration thereof. It should be noted that in the electronic device 100 with an optical input function according to the present example, since the configuration of the optical information input device 10 is substantially the same as in the embodiment described above, the constituents common to the embodiment are denoted with the same reference symbols, and the explanation therefor will be omitted.

The electronic device 100 with an optical input function shown in FIGS. 11 and 12 is provided with the optical information input device 10 and the image generation device 200, and the optical information input device 10 is provided with the position detection light sources 12 for emitting the position detection light beams, the light guide plate 13, and the light receiving device 15. The image generation device 200 is composed mainly of a liquid crystal device 209 as a direct view display device and a translucent cover 30. The liquid crystal device 209 is provided with an image display area 20R in a region overlapping the light guide plate 13 in a plan view, and the image display area 20R overlaps the input area 10R in a plan view.

In the electronic device 100 with an optical input function according to the present example, an optical sheet 16 for achieving equalization of the position detection light beams L2a through L2d is disposed on the light emission side of the light guide plate 13 if necessary. In the present example, as the optical sheet 16 there are used a first prism sheet 161 opposed to the light emitting surface 13s of the light guide plate 13, a second prism sheet 162 opposed to the first prism sheet 161 on the side opposite to the side on which the light guide plate 13 is located, and a light scattering plate 163 opposed to the second prism sheet 162 on the side opposite to the side on which the light guide plate 13 is located. It should be noted that on the side of the optical sheet 16 opposite to the side on which the light guide plate 13 is located, there is disposed a rectangular frame shaped light blocking sheet 17 in the periphery of the optical sheet 16. Such a light blocking sheet 17 prevents the position detection light beams L2a through L2d emitted from the position detection light sources 12A through 12D from leaking.

The liquid crystal device 209 (the image generation device 200) has a liquid crystal panel 209a disposed on the side of the optical sheet 16 (the first prism sheet 161, the second prism sheet 162, and the light scattering plate 163) opposite to the side on which the light guide plate 13 is located. In the present example, the liquid crystal panel 209a is a transmissive liquid crystal panel, and has a structure obtained by bonding two translucent substrates 21, 22 with a seal member 23 and filling the gap between the substrates with a liquid crystal 24. In the present example, the liquid crystal panel 209a is an active matrix liquid crystal panel, and one of the two translucent substrates 21, 22 is provided with translucent pixel electrodes, data lines, scan lines, and pixel switching elements (not shown) while the other thereof is provided with a translucent common electrode (not shown). It should be noted that it is also possible to form the pixel electrodes and the common electrode on the same substrate. In such a liquid crystal panel 209a, when a scan signal is output to each of the pixels via the scan lines, and an image signal is output via the data lines, the orientation of the liquid crystal 24 is controlled in each of the plurality of pixels, and as a result, an image is formed in the image display area 20R.

In the liquid crystal panel 209a, one 21 of the translucent substrates 21, 22 is provided with a substrate projection 21t projecting toward the periphery from the contour of the other 22 of the translucent substrates 21, 22. On the surface of the substrate projection 21t, there is mounted an electronic component 25 constituting the drive circuit and so on. Further, to the substrate projection 21t, there is connected a wiring member 26 such as a flexible printed circuit board (FPC). It should be noted that it is also possible to mount only the wiring member 26 on the substrate projection 21t. It should also be noted that a polarization plate (not shown) is disposed on the outer surface side of the translucent substrates 21, 22 if necessary.

Here, in order for detecting the two-dimensional position of the object matter Ob, it is necessary to emit the position detection light beams L2a through L2d toward the viewing side on which an operation with the object matter Ob is performed, and the liquid crystal panel 209a is disposed on the viewing side (operation side) of the light guide plate 13 and the optical sheet 16. Therefore, in the liquid crystal panel 209a, the image display area 20R is configured so as to be able to transmit the position detection light beams L2a through L2d. It should be noted that in the case in which the liquid crystal panel 209a is disposed on the opposite side of the light guide plate 13 to the viewing side, although the image display area 20R is not required to be configured to transmit the position detection light beams L2a through L2d, it is required to adopt a configuration that the image display area 20R can be viewed from the viewing side through the light guide plate 13 instead.

The liquid crystal device 209 is provided with an illumination device 40 for illuminating the liquid crystal panel 209a. In the present example, the illumination device 40 is disposed between the light guide plate 13 and the reflecting plate 14 on the side of the light guide plate 13 opposite to the side on which the liquid crystal panel 209a. The illumination device 40 is provided with an illumination light source 41, and an illumination light guide plate 43 for emitting the illumination light emitted from the illumination light source 41 and propagating through the illumination light guide plate 43, and the illumination light guide plate 43 has a rectangular planar shape. The illumination light source 41 is formed of a light emitting element such as a light emitting diode (LED), and emits a white illumination light L4, for example, in accordance with a drive signal output from a drive circuit (not shown). In the present example, a plurality of illumination light sources 41 is arranged along the side portion 43a of the illumination light guide plate 43.

The illumination light guide plate 43 is provided with a tilted surface 43g disposed on the surface of the light emission side adjacent to the side portion 43a (in the outer periphery of the light emitting surface 43s on the side of the side portion 43a), and the illumination light guide plate 43 has a thickness gradually increasing toward the side portion 43a. Due to the light entrance structure having such a tilted surface 43g, the height of the side portion 43a is made to correspond to the height of the light emitting surface of the illumination light source 41 while suppressing increase in thickness of the portion to which the light emitting surface 43s is provided.

In such an illumination device 40, the illumination light emitted from the illumination light sources 41 enters inside the illumination light guide plate 43 from the side portion 43a of the illumination light guide plate 43, then propagates through the illumination light guide plate 43 toward an outer end portion 43b on the opposite side, and is then emitted from the light emitting surface 43s which is a surface of another side. Here, the illumination light guide plate 43 has a light guide structure in which the light intensity ratio of the light emitted from the light emitting surface 43s to the light propagating through the illumination light guide plate 43 increases monotonically along a propagation direction from the side portion 43a toward the outer end portion 43b on the opposite side. Such alight guide structure can be realized by gradually increasing, for example, the area of a refracting surface with a fine concavo-convex shape for deflecting light or scattering light provided to the light emitting surface 43s or a back surface 43t of the illumination light guide plate 43, or a formation density of a scattering layer printed thereon toward the internal propagation direction described above. By providing such a light guide structure as described above, the illumination light L4 entering from the side portion 43a is emitted from the light emitting surface 43s in a roughly uniform manner.

In the present example, the illumination light guide plate 43 is disposed so as to overlap the image display area 20R of the liquid crystal panel 209a two-dimensionally on the side opposite to the viewing side of the liquid crystal panel 209a, and functions as a so-called backlight. It should be noted that it is also possible to dispose the illumination light guide plate 43 on the viewing side of the liquid crystal panel 209a so that the illumination light guide plate 43 functions as a so-called frontlight. Further, although in the present example the illumination light guide plate 43 is disposed between the light guide plate 13 and the reflecting plate 14, it is also possible to dispose the illumination light guide plate 43 between the optical sheet 16 and the light guide plate 13. Further, illumination light guide plate 43 and the light guide plate 13 can be configured as a common light guide plate. Further, in the present example, the optical sheet 16 is commonly used for the position detection light beams L2a through L2d and the illumination light L4. It should be noted that it is possible to dispose a dedicated optical sheet separately from the optical sheet 16 described above on the light emission side of the illumination light guide plate 43. This is because, although in the illumination light guide plate 43 there is often used a light scattering plate providing a sufficient light scattering action in order for equalizing the planar luminance of the illumination light L4 emitted from the light emitting surface 43s, if the position detection light beams L2a through L2d emitted from the light emitting surface 13s are scattered significantly in the light guide plate 13 for the position detection, the position detection is disturbed. Therefore, since it is required to eliminate the light scattering plate or to use the light scattering plate providing a relatively mild light scattering action, it is preferable to use the light scattering plate dedicated to the illumination light guide plate 43. It should be noted that the optical sheet having a light collection function such as a prism sheet (the first prism sheet 161 or the second prism sheet 162) can be used commonly.

### Installation Example to Electronic Device

Portable electronic devices to which the electronic device 100 with an optical input function explained with reference to FIGS. 9 through 12 will be explained with reference to FIGS. 13A through 13C. FIGS. 13A through 13C are explanatory diagrams of portable electronic devices (the electronic devices 100 with an optical input function) according to the invention. FIG. 13A shows a configuration of a mobile type personal computer equipped with the optical information input device 10. The personal computer 2000 is provided with the image generation device 200 as a display unit and a main body section 2010. The main body section 2010 is provided with a power switch 2001 and a keyboard 2002. FIG. 13B shows a configuration of a cellular phone equipped with the optical information input device 10. The cellular phone 3000 is provided with a plurality of operation buttons 3001, scroll buttons 3002, and the image generation device 200 as a display unit. The screen displayed on the image generation device 200 is scrolled also by operating the scroll buttons 3002. FIG. 13C shows a configuration of a personal digital assistant (PDA) equipped with the optical information input device 10. The personal digital assistant 4000 is provided with a plurality of operation buttons 4001, a power switch 4002, and the image generation device 200 as a display unit. When operating the power switch 4002, various kinds of information such as an address list or a date book are displayed on the image generation device 200.

It should be noted that as the electronic device 100 with an optical input function, an electronic device such as a digital still camera, a liquid crystal television, a video cassette recorder of either a view finder type or a direct-view monitor type, a car navigation system, a pager, an electronic organizer, a calculator, a word processor, a workstation, a video phone, a POS terminal, or a banking terminal can be cited besides the devices shown in FIGS. 13A through 13C.

The entire disclosure of Japanese Patent Application No. 2009-191724, filed Aug. 21, 2009 is expressly incorporated by reference herein.

What is claimed is:

1. An optical information input device adapted to optically detect a position of an object matter in an input area, comprising:
a first coordinate detection section adapted to detect a first coordinate corresponding to a position of the object matter in a first X-Y plane, which is an imaginary plane in the input area;
a second coordinate detection section adapted to detect a second coordinate corresponding to a position of the object matter in a second X-Y plane, which is an imaginary plane distant from the first X-Y plane in a Z direction in the input area; and
a three-dimensional information generation section adapted to generate three-dimensional information of the object matter based on the first coordinate and the second coordinate.

2. The optical information input device according to claim 1 further comprising:
a position detection light source adapted to emit a position detection light beam to be applied to the object matter in the input area to thereby form a light intensity distribution of the position detection light beam in the first X-Y plane and the second X-Y plane;
a first light detector having a light receiving section facing to the first X-Y plane; and
a second light detector having a light receiving section facing to the second X-Y plane.

3. The optical information input device according to claim 2 further comprising:
a light guide plate adapted to take in the position detection light beam emitted from the position detection light source, and then emit the position detection light beam toward the input area.

4. The optical information input device according to claim 1, wherein
the three-dimensional information generation section includes a three-dimensional movement information generation section adapted to generate three-dimensional movement information corresponding to a motion of the object matter as the three-dimensional information based on a temporal variation of the first coordinate and a temporal variation of the second coordinate.

5. The optical information input device according to claim 4, wherein
the three-dimensional movement information generation section includes at least one of
a first movement information generation section adapted to generate first movement information corresponding to a movement of the object matter in the first X-Y plane as the three-dimensional movement information,
a second movement information generation section adapted to generate second movement information corresponding to a movement of the object matter in the second X-Y plane as the three-dimensional movement information,
a third movement information generation section adapted to generate third movement information corresponding to a movement direction when the object matter moves in the Z direction as the three-dimensional movement information, and
a fourth movement information generation section adapted to generate fourth movement information corresponding to a variation of a tilt of the object matter in the input area as the three-dimensional movement information.

6. The optical information input device according to claim 4, wherein
the three-dimensional movement information generation section includes a gesture information generation section adapted to specify the motion of the object matter as one of a plurality of gesture patterns based on the three-dimensional movement information to generate gesture information corresponding to the motion of the object matter.

7. The optical information input device according to claim 1, wherein
the three-dimensional information generation section includes a tilt information generation section adapted to generate tilt information corresponding to a tilt of the object matter in the input area based on the first coordinate and the second coordinate.

8. An electronic device, comprising:
the optical information input device according to claim 1;
an electronic device main body; and
a control section adapted to make the electronic device main body perform operations different from each other based on the three-dimensional information.

9. An optical information input method adapted to optically detect a position of an object matter in an input area, comprising:
generating a first coordinate corresponding to a position of the object matter in a first X-Y plane, which is an imaginary plane in the input area, and a second coordinate corresponding to a position of the object matter in a second X-Y plane, which is an imaginary plane distant from the first X-Y plane in a Z direction in the input area; and
generating three-dimensional information of the object matter based on the first coordinate and the second coordinate.
